(19) United States
(12) Patent Application Publication
(10) Pub. No.: US 2008/0287142 A1
(43) Pub. Date: Nov. 20, 2008

(54) Location Dependent Content Provision

(76) Inventor: Benjamin W. Keighran, New South Wales (AU)

Correspondence Address: JONES DAY, 222 EAST 41ST ST, NEW YORK, NY, 10017, US

(21) Appl. No.: 11/632,764

(22) PCT Filed: Jul. 22, 2004
(86) PCT No.: PCT/AU04/00976

§ 371 Date: Jun. 20, 2008

(51) Int. Cl. H04Q 7/30

(52) U.S. Cl. 455/456.5

(57) ABSTRACT

A method of providing location dependent content to an end station using a base station. The base station receives from an end station and via a communications network, a content request, and an identifier indicative of an identity of the end station. The base station then authenticates the user or the end station using the identifier. In response to a successful authentication, the base station determines the location of the end station and determines content using the location or the content request, which is then transferred to the end station.

### BACKGROUND OF THE INVENTION

The present invention relates to a method and apparatus for providing location specific content to users, and in particular, to a system that is capable of providing location specific content to users of portable devices by determining the position of the devices.

### DESCRIPTION OF THE PRIOR ART

The reference to any prior art in this specification is not, and should not be taken as, an acknowledgment or any form of suggestion that the prior art forms part of the common general knowledge.

It is often desirable to be able to provide information to individuals regarding their current location, as well as to use information regarding the position of individuals to trigger respective events. Whilst a number of existing system for providing locational based information exist, these typically rely on the user providing details of their location, such as by providing an address, to allow a street map to be obtained.

An example of such a system is described in U.S. Pat. No. 6,757,544 which relates to a method of determining a location relevant to a user of a communications device. The method involves determining general location information and then providing location information based on this determined general location. If specific location information is required, this must be provided by the user by entering the specific location information into the communications device.

Accordingly, the provision of specific location information relies on the provision of information by the user, which therefore limits its use to situations in which the user knows their location, and also makes the system cumbersome to use.

In addition to this, it is known to provide location relevant information using location determining systems, such as GPS (Global Positioning Systems). However, the accuracy of this system is limited, and typically is unable to work accurately in built up environments where signals reflected from buildings have an impact on the accuracy with which a position can be determined.

### SUMMARY OF THE PRESENT INVENTION

In a first broad form the present invention provides a method of providing location dependent content to an end station, the method including in a base station:
(a) receiving from a communications network, a content request, and an identifier indicative of an identity of the end station;
(b) determining the location of the end station;
(c) determining content using:
   (i) the location; and,
   (ii) the content request; and,
(d) transferring the content to the end station using the identifier.

In a second broad form the present invention provides a method of obtaining location dependent content, the method including, in an end station:
(a) transferring a content request and identifier to a base station via a communications network, the base station being responsive to the content request and identifier to:
   (i) determine the location of the end station;
   (ii) determine content using:
      (1) the location; and,
      (2) the content request; and,
   (iii) transferring the content to the end station using the identifier.
(b) receiving the content from the base station, via the communications network.

In a third broad form the present invention provides a method of providing location dependent content to an end station, the method including, in a communications network:
(a) determining a content request, an identifier and location data representing the location of the end station
(b) transferring the content request, identifier and location data to a base station, the base station being responsive to the content request and identifier to determine content using:
   (i) the location; and,
   (ii) the content request; and,
(c) transferring the content from the base station to the end station using the identifier.

In a fourth broad form the present invention provides a method of charging an account associated with an end station, wherein the method includes, in the base station:
(a) determining the account requires charging;
(b) generating a charge command;
(c) transferring the charge command to the end station, the end station being responsive to the charge command to:
   (i) display a charge option to a user;
   (ii) determine the account is to be charged in accordance with input commands from the user,
   (iii) generate a predetermined message; and,
   (iv) transfer the predetermined message to a predetermined destination via a communications network; and,
(d) adding credits to the user account in response to receipt of the message at the predetermined destination.

In a fifth broad form the present invention provides a method of charging an account associated with an end station, wherein the method includes, in the end station:
(a) receiving a charge command;
(b) displaying a charge option to a user;
(c) determining the account is to be charged in accordance with input commands from the user;
(d) generating a predetermined message; and,
(e) transferring the predetermined message to a predetermined destination via a communications network the message being used to trigger charging of the user account.

In a sixth broad form the present invention provides a base station for providing location dependent content to an end station, wherein the base station:
(a) receives from a communications network, a content request, and an identifier indicative of an identity of the end station;
(b) determines the location of the end station;
(c) determines content using:
   (i) the location; and,
   (ii) the content request; and,
(d) transfers the content to the end station using the identifier.

In a seventh broad form the present invention provides an end station for obtaining location dependent content, wherein the end station:
(a) transfers a content request and identifier to a base station via a communications network, the base station being responsive to the content request and identifier to:
   (i) authenticates the end station using the identifier; and,
   (ii) in response to a successful authentication:
      (1) determines the location of the end station;
      (2) determines content using:
         (a) the location; and,
         (b) the content request; and,
      (3) transfers the content to the end station.
(b) receives the content from the base station, via the communications network.

In an eighth broad form the present invention provides a communications network for providing location dependent content to an end station, the communications network:
(a) determining a content request, an identifier and location data representing the location of the end station
(b) transferring the content request, identifier and location data to a base station, the base station being responsive to the content request and identifier to determine content using:
   (i) the location; and,
   (ii) the content request; and,
(c) transferring the content from the base station to the end station.

Typically the method includes, in the base station:
(a) authenticating, using the identifier, at least one of:
   (i) the user; and,
   (ii) the end station; and,
(b) providing the content in response to a successful authentication.

Typically the method includes, in the base station:
(a) using the identifier to determine a user profile; and,
(b) determining the content using the user profile.

Typically the method includes, in the base station, determining the location in accordance with location data provided by the communications network.

Generally the communications network is a local communications network, and wherein the location data includes an indication of the position of the end station with respect to the communications network.

Generally the communications network includes a number of local communications networks, and wherein the location data includes an identity of the respective communications network.

Typically the base station includes a local processing system coupled to the local communications network and a central processing system, and wherein the method includes, in the local processing system:
(a) receiving the identifier from the local communications network;
(b) determining if the user profile is stored locally; and,
(c) in response to a successful determination authenticating the end station; and,
(d) in response to an unsuccessful determination:
   (i) obtaining the user profile from the central processing system; and,
   (ii) authenticating the end station.

The base station can includes a local processing system coupled to the local communications network and a central processing system, and wherein the method includes, in the local processing system:
(a) receiving the content request from the local communications network;
(b) determining the required content;
(c) determining if the content is stored locally; and,
(d) in response to a successful determination providing the content to the end station; and,
(e) in response to an unsuccessful determination:
   (i) obtaining the content from the central processing system; and,
   (ii) providing the content to the end station.

The method can include, in the local processing system, and if the content is stored locally:
(a) determining a time stamp associated with the content;
(b) comparing the time stamp to predetermined criteria; and,
(c) obtaining the content from the central processing system in response to an unsuccessful comparison.

Generally the communications network includes a carrier communications network, and wherein the location data includes a cell identifier representing a cell within which the end station is located.

Typically the method includes, in the base station:
(a) generating menu data;
(b) transferring the menu data to the end station, the end station being responsive to the menu data to:
   (i) display a menu to a user; and,
   (ii) determine the content request in accordance with input commands from the user; and,
   (iii) transfer the content request to the communications network; and,
(c) receiving the content request from the communications network.

Typically the method includes, in the base station:
(a) determining a credit value associated with the content;
(b) determining a user account from the user profile;
(c) determining if the user account includes sufficient credit to provide the content; and,
(d) in accordance with a successful determination:
   (i) providing the content; and,
   (ii) deducting the credit value from the user account.

The method may include, in the base station, and in response to an unsuccessful determination:
(a) transferring charge data to the end station, the end station being responsive to the charge data to:
   (i) display a charge option to a user;
   (ii) determine the account is to be charged in accordance with input commands from the user;
   (iii) generate a predetermined message; and,
   (iv) transfer the message to a predetermined destination; and,
(b) adding credits to the user account in response to receipt of the message at the predetermined destination.

The message may be at least one of:
(a) an SMS; and,
(b) a premium rate message.

The method can include, in the base station, generating the user profile during a registration procedure.

Typically the method includes, in the communications network:
(a) monitoring for unconnected end stations; and,
(b) upon detection of an unconnected end station, establishing a connection with the unconnected end station connected to the communications network as a slave.

Typically the method includes, in the communications network:
(a) allowing a connection to be established by an end station with the connected to the communications network as a master;
(b) terminating the connection; and,
(c) establishing a connection with the end station connected to the communications network as a slave.

The method may include, in the end station:
(a) determining a current location;
(b) comparing the current location to a list of predetermined locations; and,
(c) in response to a successful comparison establishing a connection with the end station connected to the communications network as a master.

The method can include, in the end station:
(a) determining the current location from a carrier network; and,
(b) establishing the connection with a local communications network.

Typically the method includes, in the base station:
(a) receiving from an end station, via a carrier communications network, a carrier identifier;
(b) determining a local identifier using the carrier identifier; and,
(c) transferring the local identifier to a local communications network, the local communications network being responsive to establish a connection with the end station.

Typically the method includes:
(a) attempting to establish a connection with the end station via a local communications network; and,
(b) in response to an unsuccessful attempt, attempting to establish a connection with the end station via carrier communications network.

Typically the method includes, in the base station:
(a) receiving, from the communications network, an identifier detected from an end station in a discoverable state;
(b) determining if the end station has been previously connected;
(c) in response to a successful comparison, determining if the communications network can connect to the end station; and,
(d) in response to an unsuccessful determination:
   (i) establishing a connection with the end station; and,
   (ii) performing a registration procedure.

The typically method includes, in the base station:
(a) determining from the end station if a connection is to be established;
(b) in response to a successful determination, determining from the end station user details; and,
(c) generating a user profile.

Typically the base station is coupled to a content store which stores content, the content being associated with an indication of a respective content category, and wherein the method includes, in the base station, selecting content using a content category indicated in at least one of:
(a) the content request; and,
(b) a user profile.

The method can include, in the base station:
(a) receiving content from one or more content providers;
(b) determining categories for the content; and,
(c) storing the content in the content store with the indication of the category.

The method may include, in the base station, causing the end station to display a menu in accordance with the categories.

The method can include, in the base station:
(a) receiving content and associated time indication;
(b) storing the content in the content store; and,
(c) making the content available to end stations in accordance with the time indication.

Typically the communications network includes a pico-cell.

Typically the method includes, in the base station, generating AT commands representing at least one of:
(a) content;
(b) menu data; and,
(c) other data.

Typically the method includes at least one of converting and compressing the content before it is transferred to the end station.

The method may include, in the communications network, determining the location of the end station using at least one of:
(a) the identity of a cell within which the end station is located; and,
(b) the strength of signals received by a network node.

The base station can include at least one database and at least one processing system which implements:
(a) a gateway for receiving content;
(b) a portal for interacting with the at least one database; and,
(c) a converter for converting content for transfer to the end station.

The base station may further implement at least one of:
(a) a compression module for compressing data; and,
(b) a web interface.

The end station can be adapted to communicate with at least one of:
(a) a local communications network using a short range wireless communications protocol; and,
(b) a carrier communications network using a long range wireless communications protocol.

Typically the communications network includes a number of transceivers adapted to communicate with the end station using a local wireless communications protocol.

Typically the communications network is a wireless Bluetooth network.

Typically the communications network is a pico-cell.

Typically the communications network is a mobile phone network.

In a ninth broad form the present invention provides a method of providing location dependent monitoring, the method including in a base station:
(a) for a predetermined location, determining from a communications network, details of any end stations within the predetermined location;
(b) comparing the details to predetermined criteria;
(c) in response to the results of the comparison:
   (i) generating notification data; and,
   (ii) transferring the notification data to a predetermined destination.

In a tenth broad form the present invention provides a method of providing location dependent monitoring, the method including in a communications network:
(a) for a predetermined location, determining details of any end stations within the predetermined location;
(b) transferring the end station details to a base station, the base station being responsive to:
   (i) compare the details to predetermined criteria;
   (ii) in response to the results of the comparison:
      (1) generating notification data; and,
      (2) transferring the notification data to a predetermined destination.

In a eleventh broad form the present invention provides a base station for providing location dependent monitoring, the base station:
(a) for a predetermined location, determining from a communications network, details of any end stations within the predetermined location;
(b) comparing the details to predetermined criteria;
(c) in response to the results of the comparison:
   (i) generating notification data; and,
   (ii) transferring the notification data to a predetermined destination.

In a twelfth broad form the present invention provides a communications network for providing location dependent monitoring, the communications network:
(a) for a predetermined location, determining details of any end stations within the predetermined location;
(b) transferring the end station details to a base station, the base station being responsive to:
   (i) compare the details to predetermined criteria;
   (ii) in response to the results of the comparison:
      (1) generating notification data; and,
      (2) transferring the notification data to a predetermined destination.

Typically the method includes, in the base station:
(a) determining a location profile; and,
(b) determining from the location profile at least one of:
   (i) the predetermined location; and,
   (ii) the predetermined criteria.

The method can include, in the base station, determining from the location profile, at least one of:
(a) notification data requirements; and,
(b) the predetermined destination.

Typically the criteria include at least one of:
(a) a number of end stations;
(b) time information; and,
(c) user attributes.

The user attributes may include at least one of:
(a) user gender;
(b) user age;
(c) user interests;
(d) user name; and,
(e) user address.

Typically the method includes, in the base station:
(a) for each end station:
   (i) determining an identifier indicative of an identity of the end station; and,
   (ii) determining a user profile using the identifier; and,
(b) determining user attributes from the user profile.

Typically the method includes, in the base station, determining details of the end stations in response to an external trigger.

Typically the method includes, in a processing system responding to the notification data to thereby present content to at least one user.

### BRIEF DESCRIPTION OF THE DRAWINGS

An example of the present invention will now be described with reference to the accompanying drawings, in which:—

FIG. 1 is a schematic diagram of an example of a system suitable for providing locations specific content;

FIG. 2 is a schematic diagram of an example of the processing systems of FIG. 1;

FIG. 3 is a schematic diagram of an example of an end station of FIG. 1;

FIG. 4 is a flow chart outlining an example of the procedure of providing location specific information to a user;

FIGS. 5A and 5B are a flow chart of an example of a registration procedure;

FIGS. 6A, 6B and 6C are a flow chart of an example of the process of providing location specific information to a user;

FIG. 7 is a schematic diagram of an example of the functionality implemented by the base station of FIG. 1; and,

FIG. 8 is a flow chart of an example of a monitoring process.

### DETAILED DESCRIPTION OF THE PREFERRED EMBODIMENTS

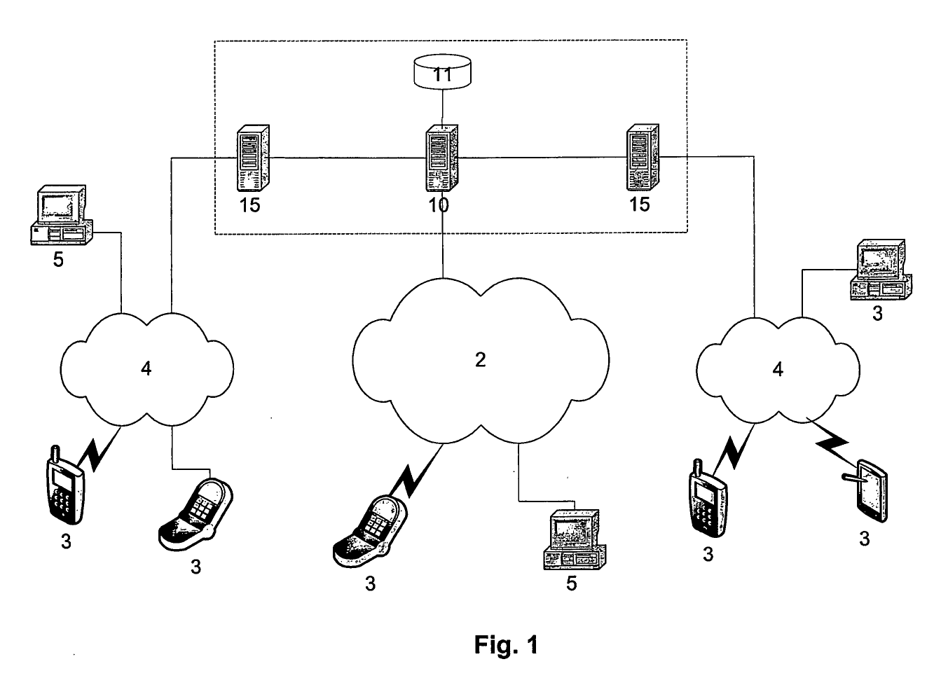

An example of the process of providing location specific content will now be described with reference to FIGS. 1 to 4.

In particular, FIG. 1 shows an example of a system suitable for providing location specific content. The system is formed from a base station 1 coupled to a number of end stations 3 via respective communications networks 2, 4. Additionally a number of content supplier end stations 5 may be provided, as will be explained in more detail below.

In use, the end stations 3 are adapted to communicate with the base station 1 via the communications networks 2, 4. The base station 1 uses information from the communications networks 2, 4 to determine the location of the end stations 3 and then provide location specific content. Accordingly, the communications networks must be capable of allowing interaction between the end stations 3 and the base station 1.

It will be appreciated by persons skilled in the art that a number of different architectures may be used. Thus, although only a single communications network 2, and two communications networks 4 are shown any number may be provided, and this is or the purpose of illustration only.

In one example the communications network 2 is a network having a wide area of coverage, such as a telecommunications network such as the 2 G, 2.5 G, 3 G, or other mobile phone networks, or the like. Alternatively however the communications network may be a WAN, the Internet, or the like. Similarly, the communications networks 4 may be local communications networks, such as picocell arrangements formed from number of transmitters provided in a predetermined area. This may include for example a local network contained within a shopping centre, a building or other complex.

In this example, the base station 1 may be formed from a central processing system 10 coupled to a database 11, and a number of local processing systems 15. In this arrangement, shown in FIG. 1, each local processing system 15 is connected to a respective local network 4 to allow local interaction with the local network 4. In this arrangement, the central processing system 10 typically operates to control the operation of the processing systems 15, and provides interaction with a database 11 and the communications network 2.

It will therefore be appreciated that in this example the base station 1 may be distributed over a number of different locations with respective local processing systems 15 provided at each location, although this is not essential.

In this case, all information or content relating to the system may be maintained centrally in the database 11. However, to reduce bandwidth requirements for data transfer between the central processing system 10 and the local processing systems 15, it is typical for each of the local processing systems 15 to maintain a local cache which is used to temporarily store data, as shown for example at 16 in FIG. 1. In this case, when data is transferred to a local processing system 15 this will temporarily store the data so that if it is required locally in the near future, it can be accessed without the need to download the data from the database 11. The data is stored temporarily so that as data is updated in the database 11, these changes are automatically reflected in the data stored locally.

In any event, the processing systems 10, 15 must be capable of interacting with the end stations 3 via the respective communications networks 2, 4. It will therefore be appreciated that a number of different forms of processing system 10, 15 and end station 3 can be used.

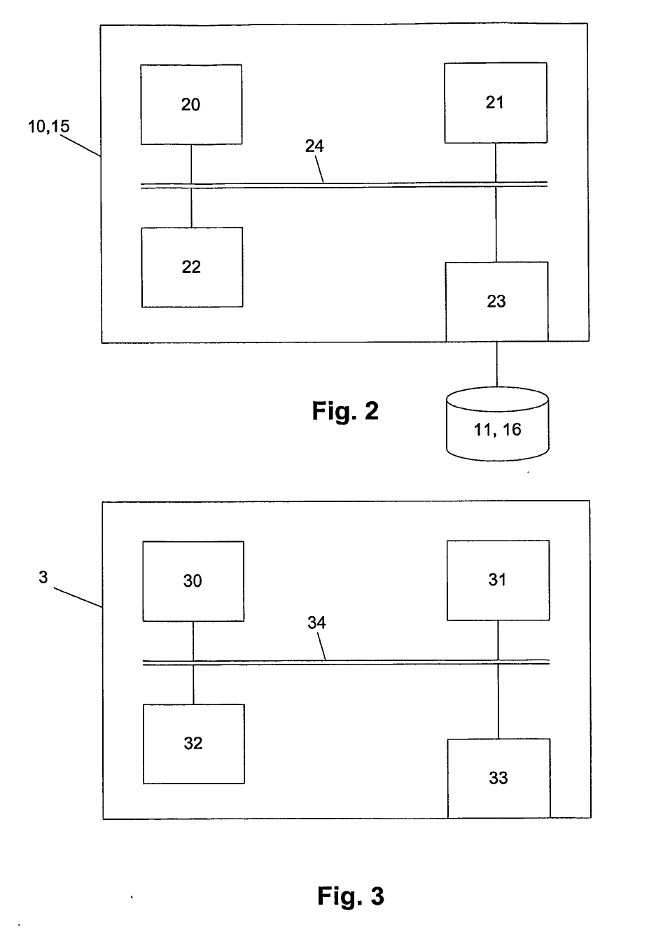

An example of a suitable processing system 10, 15 is shown in FIG. 2. As shown the processing system includes a processor 20 coupled to a memory 21, and import/output device 22 such as keyboard and display, or the like, and an external interface 23, via a bus 24. In use the external interface 23 maybe used to interconnect the processing systems 10, 15, as well as to connect the processing systems with the communications networks 2, 4, as required.

It will therefore be appreciated that the processing systems 10, 15 may be any suitable form of processing system 10, 15, such as a server, computer, laptop, desktop, or the like. For the purposes of the following discussion and for clarity purposes only these will generally be referred to as the central server 10 and local servers 15.

Similarly, the end stations 3 typically include a processor 30, a memory 31, a input/output device 32, and an external interface 33 coupled together via a bus 34. In this case the end stations may be adapted to communicate with the communications networks 2, 4 either through wired or wireless connections, which will be achieved using the external interface 33.

Typically however, these devices are adapted to provide wireless communication such that a physical connection to the communications network 2, 4 is not required. In this case, as the communications networks 2, 4 may use different communications protocols, it is typical that the external interface 33 is capable of communicating in accordance with one or both of the protocols. Thus, for example, the end station 3 may be adapted to communicate via the communications network 2, such as a mobile phone network, or the like, and a local network 4, such as a Bluetooth network.

It will therefore be appreciated that the end stations 3 may be of any suitable form such as a personal computer, laptop, tablet, PDA, pocket PC, mobile phone, or the like.

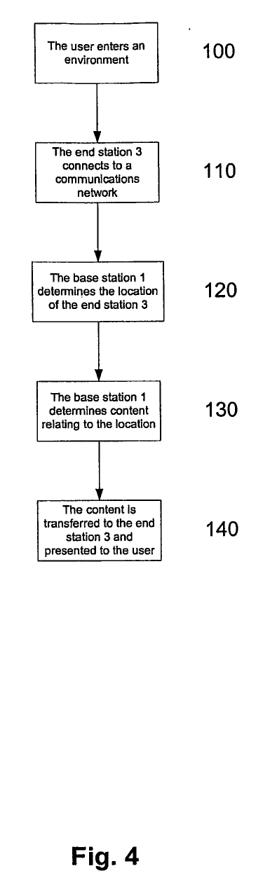

In any event, the manner in which the base station 1 operates to provide content to a user of one of the end stations 3 will now be described with reference to FIG. 4. In this particular example, the user enters an environment where the process is implemented, such as a shopping centre, convention centre, office building, sports stadium, or the like at step 100.

At step 110, the end station 3 connects to one of the communications networks 2, 4, with the base station 1 utilising the connection to determine the location of the end station 3 at step 120. The base station 1 then determines content relating to the determined location at step 130, before transferring the content to the end station at step 140. This allows the content to be presented to the user so that they are provided with content such as content relating to their location.

In this regard, the content may be relevant to the general environment, or may more specifically be relevant to the user's location within the environment, and this will depend on a number of factors, such as the content requested.

Thus, for example, when a user enters a shopping centre, the user can be provided with access to a menu which allows the user to find out content regarding the shopping centre, the shops within the centre, and any events or special offers or the like. This can be achieved by presenting the user with a menu having a number of categories of content by selecting an appropriate menu option the user can then be presented with more detailed content.

In addition to the content being provided solely on the basis of the users presence within the respective location, more detailed specific location content can be used to pinpoint the position of the user within the building. This is typically achieved using the local communications network, such as a pico-cell provided within the building to allow the users location to be determined with accuracy. The user can then be presented with content specific to that location. Thus, for example, the user can query the base station 1 using the end station 3 and request directions to a certain location within the shopping centre. The base station 1 will determine the user's current location and then provide appropriate directions to the user via the end station 3.

An example of the process will now be described in more detail.

In particular, prior to using the system, it is typical for the user to undergo a registration process. This is performed so that the user can be charged nominal amounts for accessing the content to thereby generate revenue for the content providers or system operator. In addition to this, this allows useful information to be collected regarding use of the respective environment as will be described in more detail below.

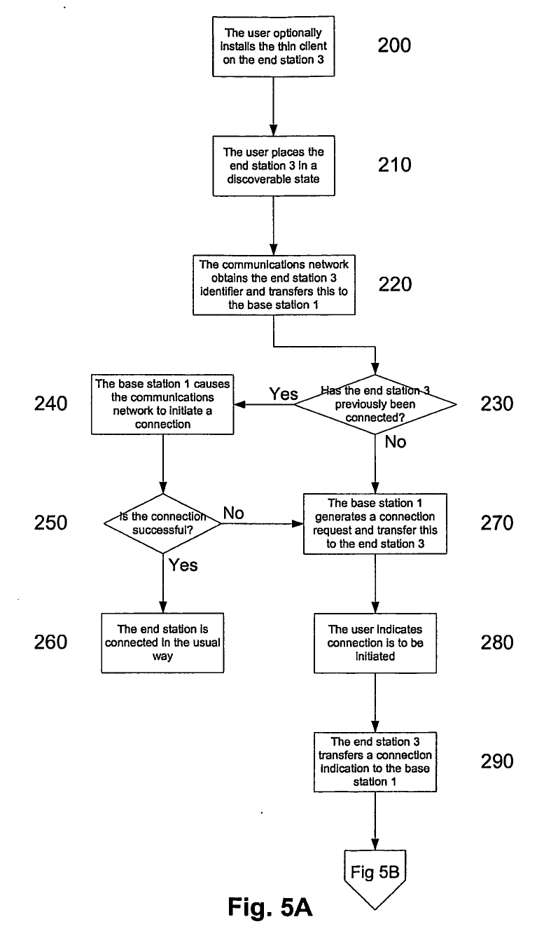

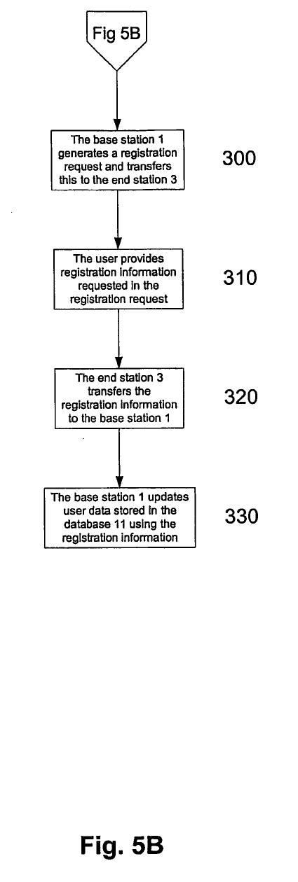

An example of a suitable registration system will now be described with reference to FIGS. 5A and 5B.

In this example at step 200 the user optionally installs a thin client on their end station 3. The thin client is a software application which is executed by the processor 30 to allow the end station 3 to perform the functionality required to interact with the system. In particular the thin client is adapted to communicate with the base station 1 in accordance with a predetermined protocol, as well as to allow the end station 3 to be placed in a “discoverable” state so that it may be automatically detected by the communications networks 2, 4.

It will be appreciated by persons skilled in the art that not all end stations 3 will require such a thin client as in some cases this functionality is integrated with an existing applications software implemented within the end station 3.

In any event at step 210 the user places the end station 3 in a discoverable state. The communications networks 2, 4 detect the discoverable state and then operate to obtain an identifier from the end station 3, which is transferred to the base 1 at step 220. The identifier is an identifier used to uniquely identify the end station 3 when it is connected to the respective network, and will therefore depend on the respective implementation as will be described in more detail below. It will be appreciated from this that any one end station 3 may be associated with respective identifiers for each of the relevant communications networks 2, 4.

At step 230 the base station 1 determines if the end station 3 has been previously connected to the system on the basis of the identifier. In order to achieve this, the base station 1 will compare the identifier to a list of identifiers of previously connected end stations 3 which are stored in the database 11.

If the end station 3 has been previously connected, and the base station 1 causes the relevant communications network 2, 4 to initiate a connection with the end station 3. In this instance, the establishment of a connection will require authentication of the user, as will be described below, which will in turn require comparison of the identifier with user profiles maintained in the database 11. The user profiles include details of existing registered users of the system, together with an indication of the respective end station 3 they use to obtain the services. Thus each user profile will specify the identifier of the user's respective end station 3.

Thus, if this connection is successful at step 250, this indicates that the respective end station is associated with a registered user, and the process can therefore move on to step 260, with the end station being connected to the system in the usual way.

However, if the connection is not successful or if the end station 3 has not been previously connected, this indicates that the device is not currently associated with a registered user. Thus, for example, the end station 3 may have been previously connected to the network by a previous user. If the user registration has expired, or if the end station is sold to another individual, the system will determine that although the end station 3 has been previously connected, it is not currently associated with a registered user, and cannot therefore access the services of the base station 1, without the current user undergoing registration.

As a result, the base station 1 is required to set up a new user account by performing a registration procedure. Accordingly, at step 270 the base station 1 generates a connection request and transfers this to the end station 3 via the respective communications networks 2, 4. At step 280 the end station 3 will display an indication that a connection is requested and allow the user to indicate whether connection is to proceed. Thus, for example, this may ask the user if they wish to register with the content provision system.

Assuming the user wishes to proceed, they will provide a suitable indication to the end station 3, which will in turn transfer a connection indication to the base station 1, at step 290. At step 300 the base station will generate a registration request and transfer this to the end station 3.

The registration request is used to request information regarding the user, such as personal details such as name, address or the like. This may also include billing details which allow the user to be billed in a default manner for provided content. In this regard, the system may use a credit system in which the user purchases credits, with the billing details defining a mechanism for debiting the user for purchased credits. The user may also be requested to provide an indication of categories or types of content of interest. This may be achieved by providing details of hobbies, interests or the like, with these being translated into relevant categories by the base station 1, as will be described in more detail below.

The user provides the requested information in the registration request at step 310 with this being transferred to the base station 1 at step 320. It will be appreciated whilst this is typically achieved via the end station 3, the level of information required may be cumbersome to enter via the end station 3, for example if the end station 3 is a mobile phone with limited input capabilities. In this case the user may submit additional content via a subsequent process, such as via accessing base station 1 via an Internet connection, or by submitting paper forms or the like.

At step 330 base station 1 updates user data stored in the database using the registration information. Thus, the base station 1 typically generates a user profile which includes details of the user, together with an indication of the end station identifier.

As mentioned above, the nature of identifier will depend on the particular network architecture used. In one example, in which the communications network 2 is a carrier communications network, such as a mobile phone network, and the communications networks 4 are local networks, then two different identifiers will be associated with the device, hereinafter generally referred to as the “carrier identifier” and “local identifier” respectively.

The carrier identifier may be in the form of a mobile phone member or the like whilst the local identifier will typically be in the form of a hardware address, such as an MAC (media access control) address. In this case, the base station 1 will typically operate to obtain both identifiers if possible. It will be appreciated from this that the registration procedure may therefore be a two stage registration procedure with registration being performed via both of the communications networks 2, 4 separately. However, this is not essential and the identifier associated with one of the communications networks 2, 4 may be obtained via the other communications networks 2, 4.

In general the registration information is stored in the database 11 in the form of user profiles. This allows the user profiles to be accessed by any one of the servers 10, 15, thereby allowing the user to obtain content from any one of the locations associated with the system.

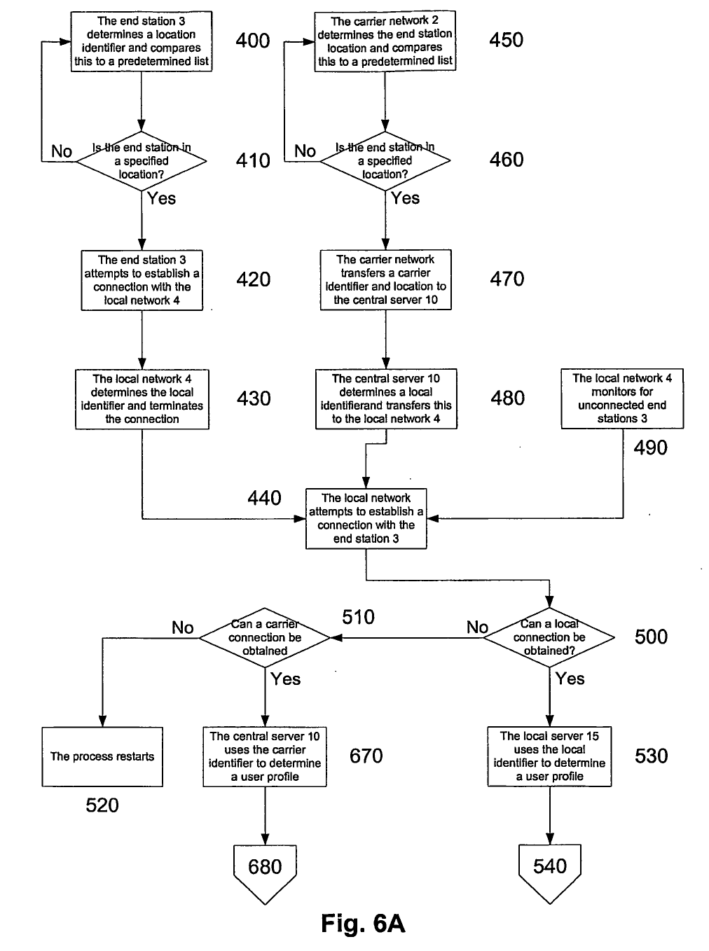

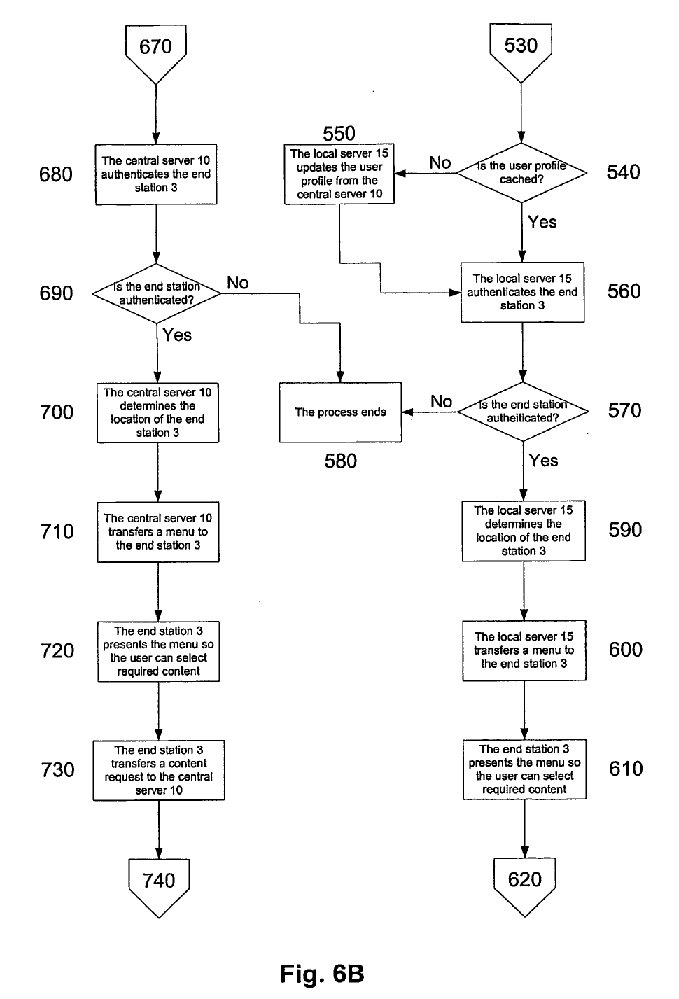

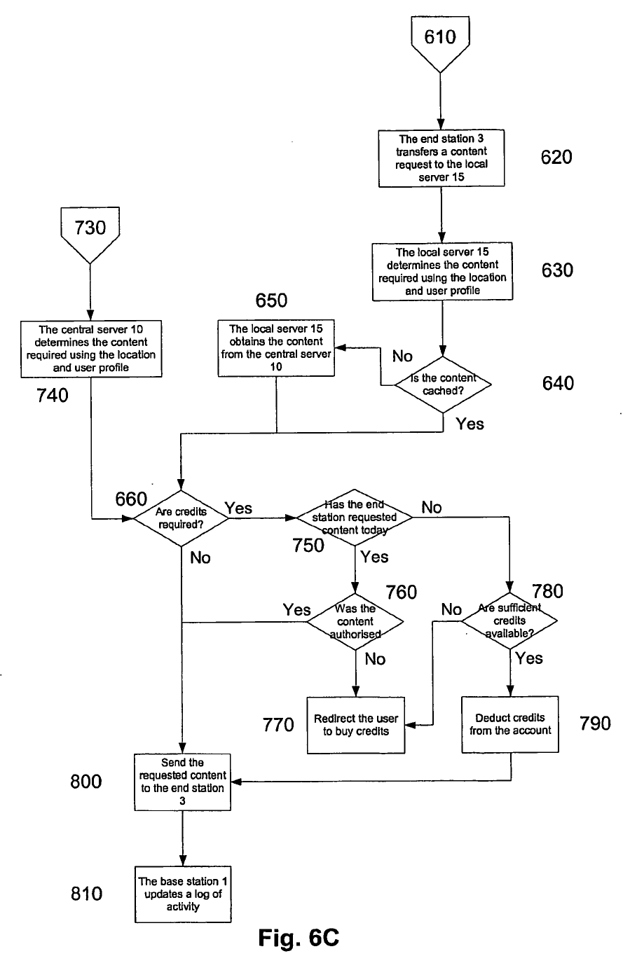

An example of the procedure by which content may be provided to user will now be described with reference to FIGS. 6A, 6B and 6C.

In particular, the first stage is for a connection to be established between the end station 3 and one of the communications networks 2, 4. This may be achieved in a number of manners but is typically performed so that the end station 3 is preferentially connected to one of the local networks 4.

A first manner in which this may be achieved is shown in steps 400 to 440. In this example, the end station 3 operates to determine a location identifier and compare this to a list of predetermined locations at step 400. The location identifier may be any form of identifier such as cell information determined from the carrier network 2. This is generally performed constantly in the background by the processor 30 so that if it is determined that the end station 3 is not in a specific location at step 410, the process returns to step 400 to be repeated.

If at any stage the processor 30 determines that the end station 3 is in specified location, this indicates that the end station 3 is an environment for which location dependent content is available. Accordingly, the end station 3 attempts to establish a connection with the local network 4 at step 420.

In this instance, the end station 3 will typically attempt to establish a connection with the end station 3 as the master for the connection. This is due to the connectivity nature of local communication protocols such as Bluetooth, which generally require the connection initiator to be the master.

However, in order to provide the required functionality, it is generally preferable for the end station 3 to be connected to the local network 4 as a slave. Accordingly, the local network 4 uses the established connection to determine the local identifier of the end station 3 and then terminates the connection at step 430, before attempting to establish a new connection with the end station 3, at step 440.

In an alternative example the carrier network 2 can determine the location of the end station 3 and compare this to a predetermined list at step 450. This is performed in a manner similar to that performed by the end station 3 at step 400 and 410, and may be based on the current network cell within which the end station 3 is located, and is typically performed repeatedly at step 460.

Once the carrier network 2 determines the carrier identifier it transfers this to the central sever 10 together with an indication of the location of the end station 3 at step 470. At step 480 the central server 10 determines a corresponding local identifier, and transfers this to the local network 4 which is in the user's vicinity. At step 440 the local network 4 again attempts to establish a connection with the end station 3.

In addition to this, as shown at 490 the local network 4 will typically constantly monitor for unconnected end stations 3 and attempt to establish a local connection at 440.

Thus, at step 440, the local network 4 attempts to establish a connection with the end station 3 as a slave. If it is determined that such a local connection cannot be established at step 500, the system operates to revert to a carrier network based connection and therefore attempts establish a connection via the carrier network 2. If it is determined that this cannot be performed at step 510, the process restarts at step 520.

In the event that a local or a carrier connection is established, the process of supplying content is slightly different and this will therefore be described with respect to steps 530 to 660 and 670 to 760 respectively.

At step 530 the local server 15 uses the local identifier to attempt to determine a user profile. Having determined the identity of the required user profile, the local server 15 will operate to determine if the user profile cached locally at step 540. As mentioned above, local caching is used to reduce processing and bandwidth loads on the central server 10.

If the user profile is available in the cache, the local server 15 will assess a time stamp associated with the user profile to assess if the profile has been updated. In particular, it is important to ensure that the profile is up to date to allow correct authentication of the end station 3 and hence the user. In general the base station 1 therefore operates to determine if the time stamp of the cached user profile is the same as the user profile stored in the database 11. This may be achieved in a number of manners, depending on the respective implementation. Thus, for example, the local server 15 may forward the time stamp to the central server 10 for verification. Alternatively, the local server 15 may request an indication of the time stamp of the user profile stored in the database 11 from the central server 10.

It will be appreciated that the comparison of the time stamps, which are only updated when the user profile is updated, allows the local server 15 to confirm that the user profile is valid. However, this technique may not be used, and alternatively the user profile may be downloaded each time the local server 15 is authenticating the user, or the authentication may be performed by forwarding the identifier to the central server 10.

If the user profile is not cached, or is out of date, the local server 15 updates the user profile by downloading the relevant user profile from the central server 10 at step 550. Thus, local server 15 will cause the central server 10 to access the user profile stored in the database 11 and transfer this back to the local server 15. The local server 15 will then cache the user profile in the database 16, together with an appropriate time stamp, before operating to authenticate the end station 3 at step 560.

If the end station is not authenticated at step 570, this indicates that the end station is not registered to use the system and the process ends at step 580 without any content being transferred to the user.

Otherwise at step 590 the local server 15 determines the location of the end station 3.

The manner in which this is achieved will depend on the implementation of the local network 4. Thus, for example, if the local network 4 is a pico-cell, this will include a number of wireless transceivers provided within the building. Each of these wireless transceivers will have a limited range and accordingly, the local server 15 can obtain an indication of the wireless transceiver which is closest to the end station 3 and therefore determine a location for the user.

Alternatively, or additionally, the wireless transceivers may be adapted to measure the strength of signals received from the end stations 3 and use this to more accurately determine the user location. This can be performed by triangulating the distance of the end station 3 from a number of the wireless transceivers.

In any event, in this example, the local server 15 having determined the location of the user transfers a menu to the end station 3 at step 600. The end station 3 presents the menu to the user allowing the user to select required content for display at step 610.

At step 620 the end station 3 transfers a content request to the local server 15 reflecting the selected content. The content request therefore may correspond to the selection of a menu option, a written query, or any other form of content request, depending on the respective implementation.

At step 630, the local server 15 determines the content required using one or more of:
the determined location;
the user profile; and
the content request.

Thus, the user may select the general category of food establishment available, but have specified in their user profile that they do not eat seafood. In this case, the local server 15 will therefore look for food establishments, other than seafood establishments, which are within the immediate vicinity of the end station 3.

Examples of provided content will be provided in more detail below.

At step 640 the local server 15 will determine if this required content is cached and if not obtain the content from the central server 10 at step 650. At step 660 the system determines if credits are required in order to provide this content. The remainder of the process is substantially identical regardless of whether the end station 3 is connected via the carrier network 2 or the local network 2, and will be described below.

Returning to FIG. 6A if only a carrier connection can be established the central server 10 operates to determine the user profile from the database 11 at step 670 using the carrier identifier. At step 680 the central server 10 authenticates the end station 3, with the process ending at step 580 if the end station 3 is not authenticated at step 690.

Otherwise, the central server 10 determines the location of the end station 3 at step 700. The manner in which this is achieved will depend on the respective communications network 4. Thus, in the case of the communications network 4 being a carrier network, such as mobile phone, or the like, this will typically involve the central server using a cell identifier to determine the location of the end station 3. However, if the end station 3 is equipped with GPS tracking or the like additional location information may be obtained by querying the GPS system provided on the end station 3.

It is also possible to triangulate using the carrier network 2, depending on the respective form of the network. Thus, in the case of a mobile phone network, it will be appreciated that in some forms the network is capable of triangulating the location of the device with respect to the cell transmitters. In general however, the resolution of the end station location is not as great as that obtained through the use of the local network 4.

At step 710 the central server 10 transfers a menu to the end station 1 with the end station 3 presenting the menu so the user can select required content at step 720. At step 730 the end station 3 transfers the content request to the central server 10 which then operates to determine the content required using the location, the content request and the user profile at step 740. It will be appreciated that this is generally achieved using a technique similar to that described above with respect to 630.

However, in general the location information determinable from the carrier network is not as accurate as that determined using the local network, which can typically pin-point the location of the end station 3 to within a few metres, even within a building. As a result, the content provided via the carrier network 2 is typically more general than that sent via the local network 4, and hence the local network 4 is used to establish a connection in preference to the carrier network.

In any event, once the content has been determined the process moves to step 660 as shown.

In particular, as mentioned above it is typical for a financial cost to be associated with use of the system. This cost may take any one of a number of forms, and may therefore require that the user pay a fee based on the nature of the content obtained.

In this example, the system is configured so that the user incurs a single fee for using the system on a given day, regardless of the content requested, although as will be appreciated by those skilled in the art, this is not essential.

To achieve the charging, user's typically have an account which is debited upon the provision of content. The account includes an indication of a number of credits the user has purchased, or received in some manner.

When the central or local servers 10, 15 determines the content to be transferred to the end station the respective server 10, 15 will determine if any credits are required. If credits are required, the process moves on to step 750 with the relevant server 10, 15 assessing if the end station 3 has already requested content today. If this is the case, the server 10, 15 determines if the provision of the content was authorised, at step 760. If this is not the case, the user is redirected to buy credits at step 770.

In one example the purchasing of credits may be achieved using a respective menu option. In this case, the selection of the menu option automatically triggers the generation of an SMS or other similar communication which is transferred to a predetermined number at a premium rate. The base station 1 can then confirm receipt of the SMS allowing the base station 1 to credit the user account. This is typically achieved by having the carrier network 2 post an indication of receipt of the SMS to the base station 1.

Accordingly, redirection of the user to purchase credits may correspond to causing the end station 3 to display the appropriate menu option. In the case in which the communication is an SMS, it will be appreciated that this may be sent via the communications network 2. However, any suitable method of obtaining payment from the user may be used.

Similarly, if the end station 3 has not previously requested content today, the process moves to step 780 to determine if the respective user profile has sufficient credits associated with their account. If not the user is again redirected to buy credits at step 770. Otherwise credits are deducted from the user's account at step 790.

Thus it will be appreciated that in this instance a user only expends credits once per day, allowing the user to access any amount of content that day at no additional expense.

At step 800 the requested content is transferred to the end station 3, and displayed to the user.

In addition to this, the base station 1 typically updates a log of activity at step 810.

This may include information such as an indication of the user, or demographic information regarding the user, an indication of the information requested, and the location of the user when making the request. In one example, the system is adapted to record all activity associated with the system, which will therefore typically include storing any data determined by the base station 1 in the database 11. This will include information such as movement of all users registered with the system when they are in range of the local network 4, or within the respective environment where the services are provided. In addition to this, the base station 1 will typically store an indication of all received content requests, and all content provided, together with details of the identity and location of the user end station making the request.

It will be appreciated that this information can provide feedback on system usage, as well as information which can be used for marketing or other similar purposes, as described in more detail below.

Accordingly, it will be appreciated that the above described system allows location dependent content to be delivered via a number of different mechanisms. In one example, the user is presented with a menu on an end station automatically upon entering an environment, allowing the user to select content from one of a number of categories, or via other options, such as search engines, or the like. The content can then be tailored dependent on the location of the user, and/or pre-defined options forming part of a user profile, before being presented to the user using the end station.

The level of accuracy with which the location is determined will vary depending on the methodology used. In one example, a pico-cell, or other suitable local wireless network may be used to allow the location of end stations within confined environments, such as buildings or the like. Within this process, the user can be charged for accessing the data.

A number of additional features which may form part of the above described system will now be described.

### Central Server 10

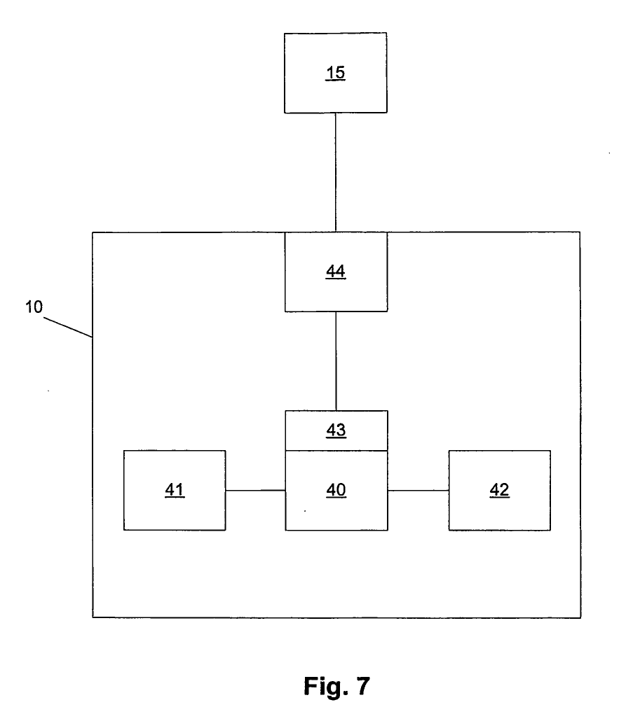

In order to ensure that content is correctly captured and made available to the users, the central server 10 may provide certain functionality an example of which will now be described with reference to FIG. 7.

In particular, FIG. 7 shows the functionality, which is typically achieved using respective modules implemented by the central server 10, including a portal 40 which is coupled to a gateway 41, web interfaces 42 and a media converter 43 which is in turn coupled to a compression/decompression module 44.

In use, the portal 40 is adapted to receive content via the gateway 41, or via the web interfaces 42 and store the content in the database 11. This therefore allows third parties to submit content for inclusion in the system, which may for example be achieved by using end stations 5 coupled to the communications networks 2, 4, or via the Internet. For example, if the system is used in a shopping centre it is typical for shops within the centre to contribute various content, such as details of special offers, location, contact information, or the like.

The operator of the base station 1 may also provide access to other content, so that the system can for example provide access to emails, news content, web services, or the like. It will therefore be appreciated that the system may provide ISP (Internet Service Provider) services.

It is also possible for users to access the content, as well as other services provided by the base station 1 via the web interface 42.

In any event, when content is received by the gateway 41, it can be assigned to certain categories, or associated with respective menu options, with additional assignments or criteria being optionally provided. The content is then stored in the database 11 together with the category and other assignment or criteria allowing the content to be subsequently retrieved.

Thus, for example, content may be associated with time information indicating when the content is to be made available. Thus, special offers may only be available for certain durations, or at certain times of the day, in which case an indication of this content is also stored in the database 11.

When content is to be downloaded to the end stations 3, the format of this content will depend on the nature of the end station 3. Thus, for example, if the end station 3 is a multimedia equipped mobile phone, this will able to receive a wider range of content than a simple text based only mobile phone. Accordingly, when the user undergoes a registration procedure the user may provide an indication of a preferred content format, or this may alternatively be determined automatically by the base station 1, for example by having the base station 1 determine the preferred format based on the device type, make or model.

When content is to be provided to the end stations 3 this is first located by the portal 40 in the database 11. The portal will first determine if the content is available for provision, for example due to the presence of any restrictions, and if so transfer it to the media converter 43, where the format of the content is adjusted as required by the respective end station 3. The content is then transferred to compression/decompression module 44 which allows the content to be compressed before being transferred to the end stations 3. This is performed to maximise the available bandwidth and to prevent overloading of the network.

Typically the end station 3 will include suitable decompression software to decompress the received content. However, if this is not available the content may be transferred in an uncompressed form.

### Local Servers 15

The local servers provide similar functionality to some of that provided by the central server 10. This will include for example, performing end station registration, authenticating user end stations, assessing the content to be provided, and obtaining content from either the local database 16, or the central server 10. This will not therefore be described in any detail.

### Communications

Communications between the base station 1 and the end stations 3 may be achieved in a number of different manners depending on the implementation. In one example, the provision of basic options, such as the displaying of text and menus may be achieved using AT commands (attention commands).

In this case, the end station 3 must be adapted to receive the AT commands and respond accordingly. However, not all end stations 3 will have a command set which will allow a menu to be generated using AT commands by default, and accordingly a thin client may be installed on the end station 3. Thus, for example, the use of suitable AT commands is not accommodated by the Symbian mobile phone operating system, and accordingly as this becomes more widespread the requirement for the presence of a thin client will increase.

In any event, the thin client is a software application which is installed on the end station 3 and which is used to receive content in an alternative form to the use of AT commands, and use the received content to provide the required functionality, such as displaying a menu.

It will be appreciated that the use of AT commands allows the base station 1 to push commands to the end station 3, thereby allowing the operation of the end station 3 to be controlled directly by the base station 1. This reduces the complexity of displaying the menu and other content on the end station 3 by reducing the need for applications software required to display different forms of content. A further benefit of this form of system is that it minimises the volume of data which is transferred to the end station 3, whilst still allowing complex functionality to be obtained.

However, additionally or alternatively, other protocols may be used, such as generic or custom versions of XML, HTML, WML or the like. Thus, if the end station cannot interpret the AT commands, it will be typical for the base station 1 to generate menus, and provide content using XML, HTML, WML or the like, with this being interpreted and displayed by the thin client as required.

Furthermore, when content is downloaded, the content may be in any one of a number of forms, such as image files, streamable media, including audio and/video sequences or the like. In the event that content of this form is to be provided, this may also require the use of a thin client which is capable of causing the content to be displayed.

In order to provide the thin client, specialised hardware may be provided. The specialised hardware may be a custom processor of the like, which is coupled to the local networks 4. In this instance, the hardware will be adapted to monitor for the presence of end stations which are in a discoverable state. The hardware will determine whether the end station 3 has been previously connected to the network, and if not determine if a thin client is installed. Thus the hardware will perform a process similar to that set out in steps 210 to 250 in FIG. 5A. in the event that the connection is not successful at step 230, or step 250, the hardware will determine if the user wishes to install the thin client through an appropriate query process, before installing the thin client as required.

It is therefore possible that this functionality could be performed by the base station 1. However, it is generally preferable to use custom hardware as this can be adapted to communicate with end stations 3 which do not have a thin client installed thereon, whereas in general, the base station 1 is adapted to communicate with end stations 3 which either do not require a thin client, or which have one already installed.

In any event, it will be appreciated from the above that the installation of the thin client may be performed as part of the registration procedure, such that the assessment of the requirement of the thin client is performed concurrently with the steps 210 to 270.

In use, the media converter operates to convert the content into a format required by the end station 3. Thus, if the content is presented through the use of AT commands, such as in the case of displaying the menu, the media converter 43 will operate to generate appropriate AT commands in accordance with instructions in the database 11. In the case in which other content such as media is provided, the content can be converted into a format suitable for display on the end station 3, for example, by providing the content in a format which can be interpreted and displayed by the thin client.

### Local Network 4

The local communications network 4 is typically a pico-cell communication network defined by a series of wireless beacons placed around a finite area such as a building or other complex. Such a pico-cell generally use short range communications protocols such as Bluetooth or the like. The wireless transceivers typically have a communications range of 10 to 15 m and therefore provided regularly throughout the complex, ensuring that the location of the user can be determined to within approximately 10 meters, although greater resolution can be obtained if triangulation is performed.

### User Account

As described above credits are used to provide access to content. Credits may be obtained using a variety of techniques, such as purchased utilising a number of manners such as credit cards, with the use of premium SMS or the like, prepaid cards or the like. Additionally, credits may be provided via alternative options, such as in conjunction with reward schemes, competition prizes, or the like.

In the event that a user attempts to access content and they have no credit available the base station 1 will typically provide an indication of the nearest location via which credits may be purchased. Alternatively, an application provided on the user end station 3 may be adapted to generate a premium rate SMS when the user indicates that they wish purchase more credits.

In this instance, as described above, this may be achieved by selecting an appropriate menu option, or by other manners. For example, the base station 1 may be arranged to send an SMS to which the user replies thereby transferring a premium rate SMS to the base station 1, thereby allowing the base station 1 to credit the user account.

Payment may alternatively be made using a number of other techniques. Thus, for example, the system can be adapted to charge a user account using credit card or charge card payments. Alternatively, users may purchase pre-paid cards or other documents, such as receipts, which include a unique identifier number. The user pays a fee for the card which corresponds to a predetermined charge amount. In use, the user provides the identifier number to the base station 1, allowing the base station 1 this to determine the value of the respective card, and hence charge the account accordingly. It will be appreciated from this that the unique identifier numbers may be generated by the base station 1, or by third parties, with the base station 1 using a mapping between a respective unique identifier number and a corresponding amount to the determine the charge amount.

In such payment systems, details such as credit card details, or the unique identifier number can be provided to the base station 1 using any one of a number of manners. Thus for example, a phone based system call centre may be implemented by the operators of the base station 1 to allow payment details to be provided via a phone, which in one example may the end station. Alternatively, the payment details can be provided by accessing the base station 1 using the web interfaces, and providing payment details via a suitable web-page.

However, any suitable payment mechanism may be used.

### Users

In the above described example, no distinction has been made between categories of user. However, it will be appreciated by persons skilled in the art that a number of different user categories may be provided.

For example, a general user category for consumers in a shopping centre may be provided. In addition to this it is also possible to provide staff categories which are assigned to end stations 3 being used by staff within the shopping centre. These may be provided with additional functionality such as the ability to update content provided in the database 11.

In addition to this, the location of staff can be monitored by the base station 1 allowing staff to be located in an emergency, or the like. In this instance, as staff enter the complex in the morning, their end station 3 will automatically register with the local network 4. The base station 1 will from then obtain updates of the locations of the staff member as they move around within the complex. This information can be stored in the database 11 so that the staff members movements throughout the day can be subsequently reviewed.

It will be appreciated that access to the content, and the ability to modify content and access other services may be controlled in accordance with the user's category, which is typically specified as part of the user profile.

### Marketing

It will be appreciated by persons skilled in the art that the process can be used to collect a large range of information which can be used for statistical analysis and marketing purposes. In particular, movement of users and in particular consumers within the shopping centre or other complex can be constantly monitored to determine typical spending patterns, content accessed by users, and the location of the respective user end station at the time of requesting content, or the like.

With the consent of users, this content could be analysed together with the user details, to provide demographic information or the like. It will be appreciated by persons skilled in the art that this content could be provided to third parties independent of the user identities, to thereby represent a further revenue stream, without adversely user's privacy.

Thus, for example, a shop offering a discount on a selected product can provide an indication of the respective discount to the base station 1, allowing this to be presented to users as previously described. In use, the base station 1 will store an indication of all content requests, supplied content, and the corresponding location of the respective end stations 3. The base station 1 can then determine statistics relating to the specific discount. This can include, for example, details of how many times content requests were received asking for details of the discount, how many times details of the discount were provided to user end stations 3, or the like.

In addition to this, the base station 1 also stores the location of user end stations 3 when such content requests were made in the log. This allows the base station 1 to determine statistics regarding the location in which such content requests were made, such as determining the number of users that were outside the respective shop at the time of making the request, or the like.

Furthermore as the base station 1 also stores the MAC address of the end station making the content request as part of the log, this can be used to subsequently access the respective user profiles associated with the user making the request. Thus, the base station 1 can provide statistics regarding the types of users viewing the respective discount. This can include details of gender, age, hobbies and interests or the like.

This allows the base station 1 to specify information such as the ratio of men to women viewing the discount, the typical location of users viewing the discount, or the like.

### Web Interfaces

The web interfaces are provided to allow web based tools to be used to query the portal and hence determine and/or modify content provided in the database 11. Data is typically secured via a 128 bit SSL encrypted link or higher.

In use, different users of the system are again provided access to the system via different web based interfaces. Access to web based interface will typically be achieved via accessing a suitable Internet link and then providing authentication information such as a user name, password, or the like.

The system typically includes an administration web interface which allows content providers, such as shops within a shopping centre or the like to access and modify content stored in the database.

In this instance, the relevant content suppliers will access a respective link on a website hosted by the central server 10 and then provide their user name and password which is authenticated in the usual way. Scripts are then provided that allow content or other content to be added, edited and modified via a series of suitable database and queries.

Typically the system will also include a web interface which allows a user to update, modify, create or otherwise manager their own user profile. Again access to this is controlled via strict authentication procedures using the user names and passwords or the like. This is performed to ensure that users only ever have access to their own user profiles.

### Monitoring

In addition, or as an alternative to providing location dependent content to user end stations, it is also possible to provide content or other information to third parties in accordance with the location of various users of the system. This may be used for a number of purposes, such as ensuring required services, such as cleaning are provided, as well as to allow the presentation of content to users via third parties.

Thus, the system can be used to provide information to third parties allowing them to respond to the presence or absence of a user in a predefined area.

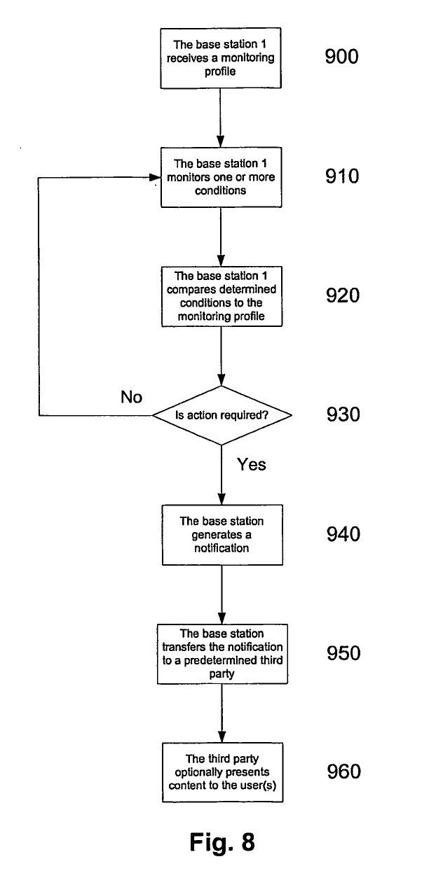

An example of this will now be described with respect to FIG. 8.

In particular, in this example, in order to allow the system to monitor for predetermined conditions, the third party generates a monitor profile at step 900. In particular, the monitor profile indicates for a given one or more locations, or for one or more specified users, criteria which the base station 1 should monitor. In general, this will include one or more criteria regarding the users that are present within a location, and will include for example, the presence or absence of specific users or categories of users, or whether specific users are in, or have been in, specific locations, as will be described in more detail below.

At step 910, the base station 1 monitors the conditions specified in the monitoring profile, such as the locations or users specified in the monitoring profile, and compares determined conditions to the specified criteria at step 920.

Thus, for example, this may include determining the number or type of users in the respective locations, or monitoring the current location of specified user. The conditions and criteria may also include temporal requirements, such as whether a predetermined user has been present in the location within a respective time period.

Having performed the comparison at step 930, the base station 1 determines if any action is required. If not, the base station 1 returns to step 900, and repeats the monitoring process. It will be appreciated that the base station may be adapted to monitor a number of different monitor profiles simultaneously, and accordingly, to avoid undue processing, the process is typically repeated at periodic time intervals.

In any event, if the base station 1 determines action is required, the base station 1 generates a notification at step 940 and transfers this to a predetermined destination at step 950. It will be appreciated that the nature and form of the notification and the predetermined destination will typically be specified in the monitoring profile.

In any event, at step 960 the third party optionally responds to the notification, for example, by presenting content to the user in the location using some predetermined mechanism.

As the process is typically performed with respect to the local network 4, the process may be performed wholly by the local servers 15, although this is not essential and other implementations may be used.

It will be appreciated that as the third party may be any entity or individual, this allows a wide range of functionality to be performed, and examples of this will now be described.

### Advertising

In one example, the third party operates to provide advertising in the locations, for example through the use of appropriate display devices. In this case, the third party may wish to trigger the presentation of adverts at locations specified in the monitoring profile. The adverts can for example be presented on a suitable display device, such as a digital display or the like.

In any event, in this instance, the third party will typically want to be able to selectively display adverts so that the displayed advert is relevant to the users currently in the respective location.

Thus, for example, the monitor profile may request that the base station 1 determine the sex of users located within 10 metres of a respective display device. Accordingly, in this instance, when the base station 1 performs step 910, the base station 1 will determine identifiers for each end station 3 located within 10 metres of the display, using the location monitoring described above. Having identified each end station 3, the base station 1 will then access the respective user profiles associated with the end stations 3, and determine the sex of the users from the profile.

The base station 1 can then compare the determined numbers of users of each sex to predetermined criteria. This may specify for example that if the relative proportion of different sexes are within a predetermined range, that no action is to be taken. However, if the users are predominantly of one sex, then adverts tailored for the respective sex can be displayed.

In this instance, the base station will transfer an indication of the predominant sex to the third party by posting an appropriate indication to a predetermined location, which may include, for example, transferring an indication to an end station, or other processing system via the communications networks 2, 4.

By generating a notification in accordance with a predetermined format, the processing system which receives the notification can be adapted to respond automatically by displaying an appropriate advert on the respective display.

It will be appreciated that in a similar manner, the adverts may be tailored to interests of the users, or even to individual users. In this latter case, the name of the user can be extracted from the respective user profile, and transferred as part of the notification. The processing system which receives the notification can then modify the advert being displayed to include the user's name.

### Staff Monitoring

The system can be used to monitor the presence or absence of staff in selected locations to ensure that sufficient staff are available to provide required services, or to ensure that specific staff are in respective locations as required.

Thus, for example, the system can be adapted to monitor areas that require cleaning to ensure that cleaning staff have checked the areas in accordance with a required cleaning schedule. In this instance, if a location has not been checked within a required time period, the base station 1 can transfer an indication of this to centre operators, allowing the operators to follow up and arrange cleaning.

Alternatively, if staff have a predetermined task schedule, which requires the staff member to be at different locations at respective times, the staff member can be monitored to ensure they are in the correct location at given times. In the event that the member of staff is not in the correct location, the member of staff can be sent a reminder, either by supplying suitable content directly to the staff members end station 3, or by informing a third party who can then notify the staff member, for example through the use of a announcement or the like.

Similarly in environments where customer supply shifts periodically, the system can monitor the location and volume of consumers and ensure adequate staff are provided to deal with the customer volume. For example, a monitor profile can be provided to monitor the number of customers in store checkout queues. In the event that the number of customers exceeds a predetermined threshold, an alter can be provided to the store, or directly to appropriate staff, via a end station 3, allowing additional staff to be assigned to the checkouts.

It will be appreciated from this, that as the system can, in the same way, monitor the location of staff, this allows staff to be automatically reassigned from quiet locations to busy locations.

### Emergencies

In the event of emergencies, such as fires or the like, the base station 1 can be adapted to monitor the location of all individuals and provide notifications to the emergency services. Thus, in this case, the monitor profile would be associated with an external trigger, such as a fire alarm. Upon detection of the external trigger by the base station 1, the base station would automatically determine the location of any users within the centre, and provide a notification of this information to the emergency services. This provides the emergency services with accurate current data as to the locations of individuals, allowing them to be located and rescued.

Furthermore, in this instance, the base station 1 can be adapted to supply predetermined evacuation instructions to the users via the respective end stations 3. This information could simply be a predefined set of instructions sent to all users. Alternatively, this could be location dependent and could include a set of directions to the nearest fire exit, or the like. In instances in which a fire location is detected, the directions could be tailored to ensure users are directed away from the fire.

It will be appreciated that in circumstances in which smoke obscures users view of other signs, it is often difficult for users to locate exits, in which case they can become trapped in a building. However, by providing location dependent directions, this can allow the user to find their way to the exit, even in absence of additional assistance.

### Example Uses

In particular, as will be appreciate by person skilled in the art the system provides a very flexible approach to data handling which allows almost any form of content to be imported into the system. This allows a wide range of content to be made available to end users. Some examples of available content in a shopping centre environment will now be described.

### Specials

This would be a menu option which provides indication of special offers for participating suppliers in the relevant complex or building. By providing this as a respective menu option this allows all specials to be viewed with a minimum number of key selection options. In addition to this, this system will be adapted to provide specials which are of interest to the user based on the user profile.

### Directory

The directory can provide directions to any shop, or other service such as facilities, ATMs, or the like. In this instance, the directory will provide directions based on the user's current location. Thus, the base station 1 monitors the user as the end station 3 moves and provides an indication of the direction in which the user should walk.

### Movie Times

For complexes including a cinema movie times can be provided based on current movies available to watch, or sharing times over the next few days.

### Organiser/Slipping List

The user profile can be adapted to generate prompts which are transferred to the user when predetermined criteria are satisfied. This can be based on the current time or location of the user, allowing the system to operate as a reminder system, or the like. This allows users to provide a shopping list or other reminders as part of their user profile. These can then be presented to the user automatically, for example as a respective menu option, which will be displayed on the user's end station when they enter the complex.

### Events

The devices can be adapted to display details of forthcoming events either upon selection of an appropriate menu option or in accordance with a predefined content request stored together with the user profile.

### User-To-User Communication

The system can be adapted to provide content regarding other users, such as their current location, as well as to allow messages to be sent between users. Thus, for example, a user may retain a list of contacts associated with their user profile. When the user connects via the communications networks 2, 4, the base station 1 will determine if any individuals indicated in the contacts list are located in the relevant building or complex and notify the user accordingly.

Accordingly, the above described system provides a transparent way for a wireless mobile device to receive relevant information across a number of communication network platforms. The technology when used in conjunction with pico-cell communication networks and networks with a similar architecture can deliver relevant information to wireless mobile devices as accurately as 10-15 m. This allows the location of a wireless mobile device to be determined and relevant information based on it's location in a building or complex to be provided.

In one example, when suitable communications networks are used, the system can determine mobile device location in buildings that have layers of concrete above them and therefore can not use traditional technologies like GPS. It provides a way for monitoring information usage and device movements whilst connected to a communications network. It also provides a way for delivering information that was generated by website, by an individual/user or provided by third party companies including but not limited to email systems, news and information systems.

Persons skilled in the art will appreciate that numerous variations and modifications will become apparent. All such variations and modifications which become apparent to persons skilled in the art, should be considered to fall within the spirit and scope that the invention broadly appearing before described.

1. A method of providing location dependent content to an end station, the method including in a base station: (a) receiving from a communications network, a content request, and an identifier indicative of an identity of the end station; (b) determining the location of the end station; (c) determining content using: (i) the location; and, (ii) the content request; and, (d) transferring the content to the end station using the identifier.

2. A method according to claim 1, wherein the method includes, in the base station: (a) authenticating, using the identifier, at least one of: (i) the user; and, (ii) the end station; and, (b) providing the content in response to a successful authentication.

3. A method according to claim 1, wherein the method includes, in the base station: (a) using the identifier to determine a user profile; and, (b) determining the content using the user profile.

4. A method according to claim 1, wherein the method includes, in the base station, determining the location in accordance with location data provided by the communications network.

5. A method according to claim 4, wherein the communications network is a local communications network, and wherein the location data includes an indication of the position of the end station with respect to the communications network.

6. A method according to claim 4, wherein the communications network includes a number of local communications networks, and wherein the location data includes an identity of the respective communications network.

7. A method according to claim 1, wherein the base station includes a local processing system coupled to the local communications network and a central processing system, and wherein the method includes, in the local processing system: (a) receiving the identifier from the local communications network; (b) determining if the user profile is stored locally; and, (c) in response to a successful determination authenticating the end station; and, (d) in response to an unsuccessful determination: (i) obtaining the user profile from the central processing system; and, (ii) authenticating the end station.

8. A method according to claim 5, wherein the base station includes a local processing system coupled to the local communications network and a central processing system, and wherein the method includes, in the local processing system: (a) receiving the content request from the local communications network; (b) determining the required content; (c) determining if the content is stored locally; and, (d) in response to a successful determination providing the content to the end station; and, (e) in response to an unsuccessful determination: (i) obtaining the content from the central processing system; and, (ii) providing the content to the end station.

9. A method according to claim 8, wherein the method includes, in the local processing system, and if the content is stored locally: (a) determining a time stamp associated with the content; (b) comparing the time stamp to predetermined criteria; and, (c) obtaining the content from the central processing system in response to an unsuccessful comparison.

10. A method according to claim 4, wherein the communications network includes a carrier communications network, and wherein the location data includes a cell identifier representing a cell within which the end station is located.

11. A method according to claim 1, wherein the method includes, in the base station: (a) generating menu data; (b) transferring the menu data to the end station, the end station being responsive to the menu data to: (i) display a menu to a user; and, (ii) determine the content request in accordance with input commands from the user; and, (iii) transfer the content request to the communications network;
and, (c) receiving the content request from the communications network.

12. A method according to claim 1, wherein the method includes, in the base station: (a) determining a credit value associated with the content; (b) determining a user account from the user profile; (c) determining if the user account includes sufficient credit to provide the content; and, (d) in accordance with a successful determination: (i) providing the content; and, (ii) deducting the credit value from the user account.

13. A method according to claim 12, wherein the method includes, in the base station, and in response to an unsuccessful determination: (a) transferring charge data to the end station, the end station being responsive to the charge data to: (i) display a charge option to a user; (ii) determine the account is to be charged in accordance with input commands from the user; (iii) generate a predetermined message; and, (iv) transfer the message to a predetermined destination; and, (b) adding credits to the user account in response to receipt of the message at the predetermined destination.

14. A method according to claim 13, wherein the message is at least one of: (a) an SMS; and, (b) a premium rate message.

15. A method according to claim 3, wherein the method includes, in the base station, generating the user profile during a registration procedure.

16. A method according to claim 1, wherein the method includes, in the communications network: (a) monitoring for unconnected end stations; and, (b) upon detection of an unconnected end station, establishing a connection with the unconnected end station connected to the communications network as a slave.

17. A method according to claim 1, wherein the method includes, in the communications network: (a) allowing a connection to be established by an end station with the connected to the communications network as a master; (b) terminating the connection; and, (c) establishing a connection with the end station connected to the communications network as a slave.

18. A method according to claim 17, wherein the method includes, in the end station: (a) determining a current location; (b) comparing the current location to a list of predetermined locations; and, (c) in response to a successful comparison establishing a connection with the end station connected to the communications network as a master.

19. A method according to claim 17, wherein the method includes, in the end station: (a) determining the current location from a carrier network; and, (b) establishing the connection with a local communications network.

20. A method according to claim 1, wherein the method includes, in the base station: (a) receiving from an end station, via a carrier communications network, a carrier identifier; (b) determining a local identifier using the carrier identifier; and, (c) transferring the local identifier to a local communications network, the local communications network being responsive to establish a connection with the end station.

21. A method according to claim 1, wherein the method includes: (a) attempting to establish a connection with the end station via a local communications network; and, (b) in response to an unsuccessful attempt, attempting to establish a connection with the end station via carrier communications network.

22. A method according to claim 1, wherein the method includes, in the base station: (a) receiving, from the communications network, an identifier detected from an end station in a discoverable state; (b) determining if the end station has been previously connected; (c) in response to a successful comparison, determining if the communications network can connect to the end station; and, (d) in response to an unsuccessful determination: (i) establishing a connection with the end station; and, (ii) performing a registration procedure.

23. A method according to claim 22, wherein the method includes, in the base station: (a) determining from the end station if a connection is to be established; (b) in response to a successful determination, determining from the end station user details; and, (c) generating a user profile.

24. A method according to claim 1, wherein the base station is coupled to a content store which stores content, the content being associated with an indication of a respective content category, and wherein the method includes, in the base station, selecting content using a content category indicated in at least one of: (a) the content request; and, (b) a user profile.

25. A method according to claim 24, wherein the method includes, in the base station: (a) receiving content from one or more content providers; (b) determining categories for the content; and, (c) storing the content in the content store with the indication of the category.

26. A method according to claim 24, wherein the method includes, in the base station, causing the end station to display a menu in accordance with the categories.

27. A method according to claim 26, wherein the method includes, in the base station: (a) receiving content and associated time indication; (b) storing the content in the content store; and, (c) making the content available to end stations in accordance with the time indication.

28. A method according to claim 1, wherein the communications network includes a pico-cell.

29. A method according to claim 1, wherein the method includes, in the base station, generating AT commands representing at least one of: (a) content; (b) menu data; and, (c) other data.

30. A method according to claim 1, wherein the method includes at least one of converting and compressing the content before it is transferred to the end station.

31-85. (canceled)
